(19) United States
(12) Patent Application Publication
(10) Pub. No.: US 2006/0291706 A1
(43) Pub. Date: Dec. 28, 2006

(54) Method of extracting intensity data from digitized image

(75) Inventors: Stephen J. Gunstream, San Francisco, CA (US); Patrick D. Kinney, Hayward, CA (US)

Correspondence Address: MILA KASAN, PATENT DEPT.;APPLIED BIOSYSTEMS, 850 LINCOLN CENTRE DRIVE, FOSTER CITY, CA, 94404, US

(73) Assignee: Applera Corporation, Foster City, CA (US)

(21) Appl. No.: 11/166,957

(22) Filed: Jun. 23, 2005

(51) Int. Cl. G06K 9/00; G06K 9/40

(52) U.S. Cl. 382/128; 382/275

(57) ABSTRACT

A method for reducing optical crosstalk in an optical array detector is provided. In various embodiments, the method can include measuring optical emission within a first region of interest (ROI) using a first plurality of pixels of the optical array detector, wherein each of the first plurality of pixels provides a value for optical signal intensity within the first ROI. An ROI sum signal can then be calculated by summing the values for optical signal intensity measured by the first plurality of pixels. An optical emission within a second ROI can be measured using a second plurality of pixels of the optical array detector, wherein each of the second plurality of pixels provides a value for optical signal intensity within the second ROI. The values for optical signal intensity provided by the second plurality of pixels can be algebraically manipulated to determine an optical crosstalk signal. A corrected ROI optical signal intensity can then be determined by multiplying the optical crosstalk signal by a number of pixels of the first plurality of pixels and subtracting the multiplied optical crosstalk signal from the ROI sum signal.

### DESCRIPTION OF THE INVENTION

1. Field of the Invention

The present invention relates to optical array imagers and, more particularly, relates to systems and methods to reduce optical crosstalk in optical array imagers.

2. Introduction

Array imaging systems that include an optical camera to monitor signals from multiple samples for analytical purposes can suffer from optical crosstalk between samples. The sources of optical crosstalk in these systems includes scattering at surfaces and multiple reflections from optical elements. For example, during polymerase chain reaction (PCR) analysis, a microtiter plate is used to hold chemical and/or biological samples. The microtiter plate typically has multiple wells, e.g., 96,384 or 1536 wells, arranged in a linear array to hold multiple samples. Each well represents a region of interest (ROI) that is illuminated by fluorescence excitation light and imaged by the camera. Problems due to crosstalk can arise, however, when some ROI's exhibit optical signals orders of magnitude larger than other ROI's. In this case, imaging and quantification of ROIs with weaker signals is difficult due to the optical crosstalk signals from the ROI's with stronger signals.

Conventional methods and apparatus for reducing crosstalk consist of introducing circular polarizers in the optical beam between pairs of reflecting surfaces. This reduces crosstalk over a small spectral range, but also reduces the optical signal level by at least a factor of 2 to 3. Introduction of polarizers may also result in additional optical surfaces that can introduce their own crosstalk problems.

Thus, there is a need to overcome these and other problems of the prior art to provide a method and system to reduce optical crosstalk without significantly reducing the optical signal level.

### SUMMARY OF THE INVENTION

According to various embodiments, the present teachings include a method for reducing optical crosstalk in an optical array detector comprising: measuring an optical signal intensity within a first region of interest (ROI) using a first plurality of pixels of the optical array detector; measuring an optical signal intensity within a second ROI using a second plurality of pixels of the optical array detector, wherein the second ROI defines a region surrounding the first ROI; estimating an optical crosstalk signal using the optical signal intensity within the second ROI; and determining a corrected ROI signal for the first ROI by subtracting the estimated optical crosstalk signal from the optical signal intensity measured within the first ROI.

In other embodiments, the present teachings include a method for reducing optical crosstalk in an optical array detector comprising the steps of: a. measuring optical emission within a first region of interest (ROI) using a first plurality of pixels of the optical array detector, wherein each of the first plurality of pixels provides a value for optical signal intensity within the first ROI; b. calculating an ROI sum signal by summing the values for optical signal intensity measured by the first plurality of pixels; c. measuring an optical emission within a second ROI using a second plurality of pixels of the optical array detector, wherein each of the second plurality of pixels provides a value for optical signal intensity within the second ROI; d. algebraically manipulating the values for optical signal intensity provided by the second plurality of pixels to determinate an optical crosstalk signal; and e. determining a corrected ROI optical signal intensity by multiplying the optical crosstalk signal by a number of pixels of the first plurality of pixels and subtracting the multiplied optical crosstalk signal from the ROI sum signal.

In still other embodiments, the present teachings include a computer-readable medium to reduce optical crosstalk in an optical array detector comprising: program code to control measurement of a plurality of values for optical signal intensity within a plurality of regions of interest (ROIs) by an optical detector, wherein the plurality of ROIs corresponding to wells of a microtiter plate; program code to calculate an ROI sum signal for each ROI by summing the plurality of values for optical signal intensity measured within each ROI; program code to control measurement of a second plurality of values for optical signal intensity within a second plurality of ROIs, wherein each of the second plurality of ROIs comprises a ring-shaped region surrounding a corresponding ROI; program code to calculate a crosstalk signal by algebraically manipulating the values for optical signal intensity measured within the second plurality of ROIs; program code to obtain a product by multiplying the crosstalk signal by a number of pixels of the detector used to measure the optical signal intensity within one of the plurality of ROIs; and program code to calculate a value for corrected optical signal intensity for each of the plurality of ROIs by subtracting the product from each of the ROI sum signals.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 depicts a portion of a 96 well microtiter plate.

FIG. 2 depicts an exemplary method for reducing crosstalk according to various embodiments of the present teachings.

FIG. 3 depicts an image of a portion of the microtiter plate showing first ROIs and second ROIs according to various embodiments of the present teachings.

FIG. 4A depicts a 96-well microtiter plate.

FIG. 4B depicts ROI sum signals for each well of the 96 well microtiter plate according to various embodiments of the present teachings.

FIG. 4C depicts corrected ROI signals for each well of the 96 well microtiter plate according to various embodiments of the present teachings.

FIG. 5 depicts a schematic of a sequence detection system according to various embodiments of the present teachings.

FIG. 6 depicts an image of a portion of the microtiter plate showing linear shaped first ROIs and second ROIs according to various embodiments of the present teachings.

FIG. 7 depicts a schematic view of a photodiode/LED system excitation and detection of signal from linear shaped first ROIs and second ROIs.

### DESCRIPTION OF THE EMBODIMENTS

In the following description, reference is made to the accompanying drawings that form a part thereof, and in which are shown by way of illustration specific exemplary embodiments in which the invention may be practiced. These embodiments are described in sufficient detail to enable those skilled in the art to practice the invention and it is to be understood that other embodiments may be utilized and that changes may be made without departing from the scope of the invention. The following description is, therefore, not to be taken in a limited sense.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5.

As used herein, the term “crosstalk” and “optical crosstalk” are interchangeable and refer to a portion of an optical signal contributed by a source or sources from outside a region of interest.

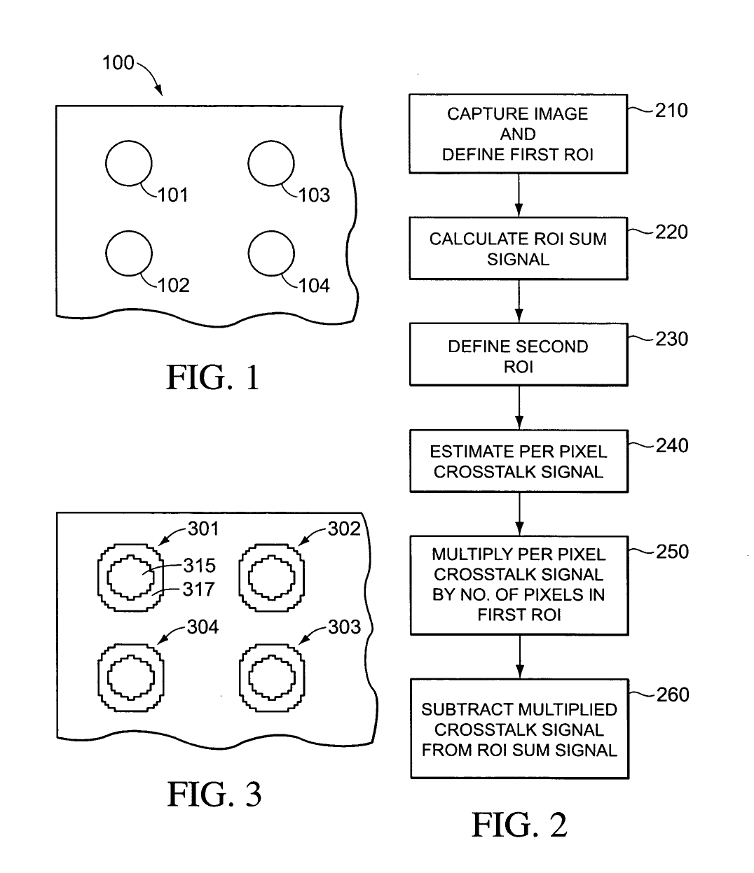

FIGS. 1 to 5 depict exemplary embodiments of methods and systems to reduce optical crosstalk. According to various embodiments, the methods can include determining an estimated crosstalk signal by detecting signals from a second region of interest that is outside of a first region of interest.

According to various embodiments, a method for reducing optical crosstalk in a measured signal is provided. For ease of understanding, the method will be described with respect to reducing crosstalk in an image from a CCD camera obtained during a PCR run. One of skill in the art understands, however, that the disclosed method can be used with other array imaging systems and techniques. During PCR analysis, samples including a dye can be placed within each well of a microtiter plate, such as, for example a 96 well microtiter plate. FIG. 1, shows a portion of a 96 well microtiter plate 100 that includes wells 101, 102, 103, and 104. The samples can then be illuminated by a source of excitation light that causes the dyes to emit fluorescent light.

FIG. 2 depicts an exemplary method for reducing crosstalk. At 210, an image of the microtiter plate can be captured by a detector, such as, for example, a CCD camera. Exposure times can vary as desired. According to embodiments, multiple images can be captured at exposure times of, for example, 150, 450, and 1200 milliseconds.

FIG. 3 depicts a portion of an image 300 captured by the CCD camera. FIG. 3 shows the image of four wells 301-304 corresponding to wells 101-104 depicted in FIG. 1. For each well of the microtiter plate, a first ROI can be defined by a first plurality of pixels of the CCD camera. For example, as shown in FIG. 3, a first ROI 315 can be defined by a first plurality of pixels that correspond to the shape and dimensions (or relative dimensions) of well 101 shown in FIG. 1. The number of pixels forming the first ROI can depend on a number of factors including, for example, the size of the well, the location of the well, the resolution of the CCD camera, the optical magnification and any distortion. In various embodiments, the first ROI for each well of the microtiter plate can be determined by analysis of a calibration image. For example, a calibration image can be captured in which a high contrast signal, relative to the background for each well, is provided. The first ROI can then be manually defined by defining an edge boundary around the first plurality of pixels. In various other embodiments, the first ROI can be automatically defined by allowing an algorithm to determine the first plurality of pixels. The shape of the first ROI can be, for example, circular.

According to various embodiments, each pixel of the first plurality of pixels can detect emitted fluorescent light and provide an optical signal representative of fluorescent light intensity from a corresponding well. The optical signal, however, can also include a component from outside the corresponding well. Referring again to FIG. 2, an ROI sum signal can be calculated at 220 by summing the signals provided by each of the first plurality of pixels.

At 230, a second ROI can be defined by a second plurality of pixels for each first ROI. For example, as shown in FIG. 3, a second ROI 317 can be defined by a second plurality of pixels that correspond to a region outside of first ROI 315. In various embodiments, the second ROI can be a ring shaped region surrounding first ROI. In various embodiments, the second ROIs can be defined based on processing of the first ROIs. For example, the second ROIs can be defined by expanding the boundary of the first ROI. In an exemplary embodiment, this can be done using computer image processing techniques, for example, by i) creating a binary image defining the first ROI; and ii) forming a second non-binary image consisting of the result of applying a low pass filter to the first ROI image; and iii) by forming a final binary image by applying a threshold to the second image.

At 240, the fluorescent light detected by the second plurality of pixels defining second ROI 317 can be used to estimate a per-pixel crosstalk signal of the signals measured by the first plurality of pixels. In various embodiments, the per-pixel estimated crosstalk signal can be determined by algebraically manipulating the signals provided by the second plurality of pixels. For example, the values of the signals provided by each of the second plurality of pixels can be used to determine an average or a median value. In various other embodiments, curve fitting can be applied to the values of the signals provided by each of the second plurality of pixels to determine an estimated per pixel crosstalk signal.

A corrected ROI signal can then be determined. At 250, the estimated per pixel crosstalk signal can be multiplied by the number of pixels of the first plurality of pixels. In other words, the estimated per pixel crosstalk signal can be multiplied by the number of pixels defining the first ROI. The corrected ROI signal can then be calculated by subtracting the multiplied estimated per pixel crosstalk signal from the ROI sum signal as shown at 260. In various embodiments, an estimated crosstalk signal can be determined for each of the multiple first ROIs of microtiter plate 100 and a corrected ROI signal can be determined for each of the multiple first ROIs, e.g., each of 96 wells. In various other embodiments, a single estimated crosstalk signal can be determined for all of the first ROIs.

In various embodiments, optical crosstalk signals can be monitored over a plurality of time intervals. A smoothing function can then be applied to the optical crosstalk signals before determining a corrected ROI signal. In an exemplary embodiment, a mean and standard deviation of the cross-talk signal values can be calculated. Cross-talk values that fall outside of a window defined as the mean plus/minus some number of standard deviations can then be excluded. In another exemplary embodiment, cross-talk signals can be smoothed as a function of time. Here, subsequent readings of the cross-talk signal for a given ROI can be smoothed using, for example, a rolling average function.

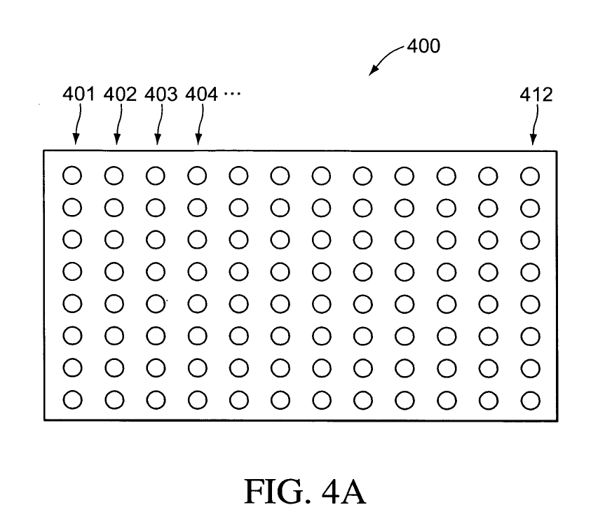

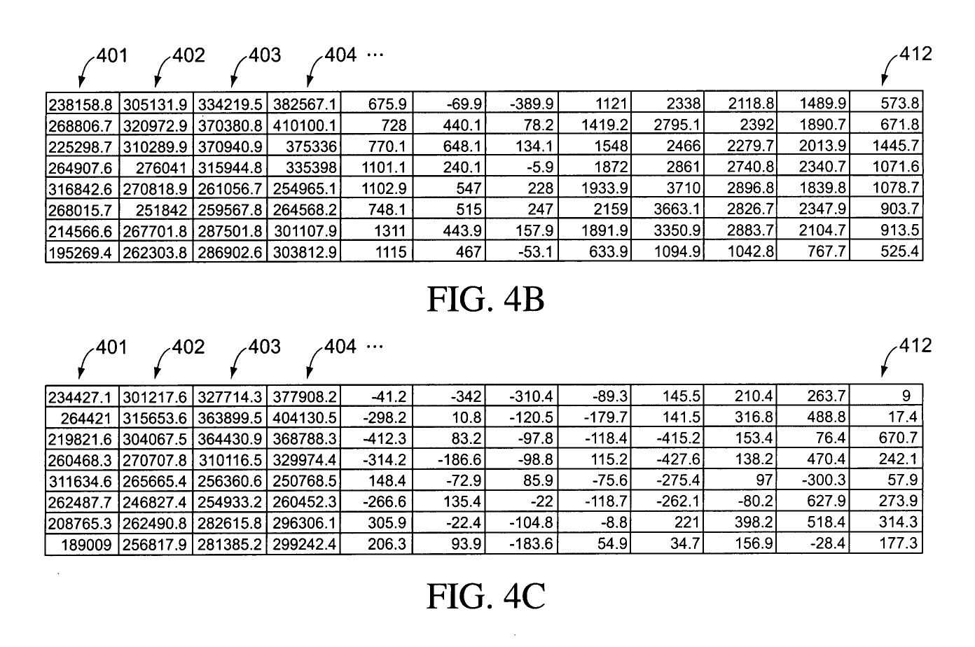

FIGS. 4A-C provide a non-limiting example of various embodiments of the disclosed method for reducing crosstalk. FIG. 4A depicts a 96-well microtiter plate 400. A highly fluorescent test sample was placed in each of the wells of columns 401-404. Using a real-time PCR system, microtiter plate 400 was then illuminated by a halogen lamp and imaged. The images were intentionally overexposed to produce a large crosstalk signal. A first ROI region was defined for each of the 96 wells using a calibration plate. An image was recorded of the calibration plate containing a calibration dye. The image was then used to define the first ROI regions. An ROI sum signal was then calculated for each of the 96 wells. The 96 ROI sum signals for microtiter plate 400 are shown FIG. 4B. The wells in columns 401-404, corresponding to the wells with the highly fluorescent test sample, showed high values for intensity. The wells of columns 405-412, which should ideally have intensity values of zero, showed non-zero ROI sum signals resulting from crosstalk. The cross talk was due, for example, to reflections within the system from the highly fluorescent samples in the wells in columns 401-404 of microtiter plate 400.

A second ROI region was then defined for each of the second wells. The second ROI regions were defined as ring shaped regions surrounding the first ROI regions. Each second ROI region had a nominal width of two pixels. An estimated ROI crosstalk signal was determined for each second ROI by calculating the mean of the signals from the pixels forming the second ROIs. Corrected ROI signals were then determined by multiplying the estimated ROI crosstalk signals by the number of pixels within their corresponding first ROI. The multiplied estimated ROI crosstalk signals were then subtracted from their corresponding first ROI signals to determine the corrected ROI signals. The corrected ROI signals for each of the 96 wells are shown in FIG. 4C.

In various embodiments, the estimated crosstalk signals can be stored separate from the first ROI signals during a sequence detection system run. This can allow subsequent data analysis to be performed with and/or without the signal correction from the second ROI. In various other embodiments, the estimated crosstalk signals can be applied “on-the-fly” during a sequence detection system run to eliminate the need to store and process two sets of data.

In various embodiments, a computer-readable medium to reduce optical crosstalk in an optical array detector is provided. Referring again to FIG. 2, the computer readable medium can include program code to control measurement of a plurality of values for optical signal intensity within a plurality of first regions of interest (ROIs) by an optical detector, such as, for example, a CCD camera at 210. Each of the plurality of first ROIs can correspond to wells of a microtiter plate. In various embodiments, program code can determine the number of pixels that form each of the first ROIs.

The computer readable medium can further include program code to calculate an ROI sum signal for each of the plurality of first ROIs by summing the plurality of values for optical signal intensity measured within each first ROI as shown at 220. The computer readable medium can also include program code to control measurement of a second plurality of values for optical signal intensity within a second plurality of ROIs as shown at 230. In various embodiments, the program code can automatically define one or more of the shape, the distance from the first ROI, and the number of pixels of each of the second plurality of ROIs. The shape, the distance from the first ROI, and the number of pixels of each of the second plurality of ROIs can be defined by the program code based on, for example, signal levels within the first ROI, signal levels within the neighboring ROIs, the observed spacing between neighboring first ROIs. According to various embodiments, the second plurality of ROIs can each be a ring-shaped region surrounding a corresponding ROI.

The computer readable medium can include program code to calculate a crosstalk signal by algebraically manipulating the values for optical signal intensity measured within the second plurality of ROIs as shown at 240. Program code can then obtain a product by multiplying the crosstalk signal by a number of pixels of the detector used to measure the optical signal intensity within the corresponding first plurality of ROIs shown at 250. Program code can then calculate a value for corrected ROI signal intensity for each of the plurality of ROIs by subtracting the product from each of the ROI sum signals as shown in 260. In various embodiments, the computer readable medium can further include program code to control the visual display of the corrected ROI signals as, for example, an image and/or a table of intensity values.

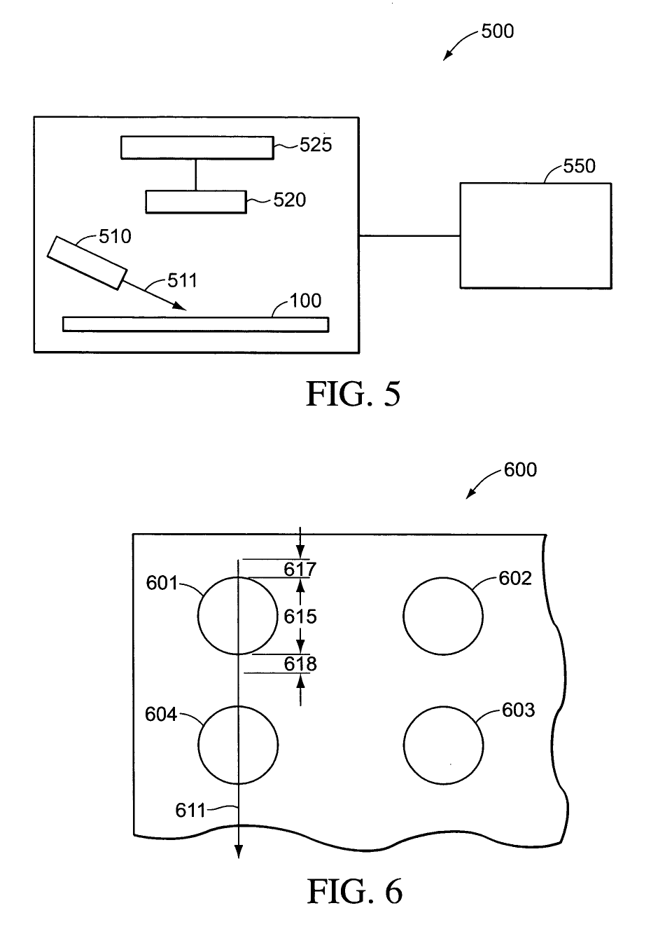

The computer readable medium can be incorporated into, for example, a sequence detection system. Referring to the schematic drawing of FIG. 5, a sequence detection system 500 can include a light source 510 that provides a fluorescence excitation light 511 and a CCD camera 520 that provides an image of a sample 100. Sample 100 can be, for example, a microtiter plate. Sequence detection system 500 can further include a computer 550 that is configured by a computer readable medium.

In various embodiments, the computer readable medium can include program code that can manipulate the image to provide a plurality of first mask zones for measuring signal intensity from each of a plurality of wells of a microtiter plate and a plurality of second mask zones, wherein each of the plurality of second mask zones measures a signal intensity surrounding a corresponding first mask zone. The computer readable medium can further include program code to sum the signal intensities within each of the plurality of first mask zones and program code to calculate a crosstalk signal for each of the plurality of first mask zones by algebraically manipulating the signal intensities measured within each of the second mask zones. The computer readable medium can further include program code to multiply each of the crosstalk signals by a number of pixels within the corresponding first mask zone, and program code to calculate a corrected signal intensity for each of the plurality of first mask zones by subtracting the multiplied crosstalk signal from the summed signal intensity of the corresponding first mask zone.

In various embodiments, the first ROIs and the second ROIs can be defined as line segments. Referring to FIG. 6, wells 601-604 of microtiter plate 600 are shown. A light emitting diode (LED) can be used as a light source and a detector, such as a photodiode, can be used as a detector and scanned, for example, along line 611. Although the scan path of the LED is depicted along a column (vertical) of wells, one of ordinary skill in the art understands that the scan path can also be across (horizontal) a row of wells. The detector can measure signal intensities as it scans along line 611. According to various embodiments, a first ROI 615 can be defined as a line segment, that portion of line 611 that provides signal intensity corresponding to well 601. While first ROI 615 can be defined as that portion of line 611 that falls within well 601, first ROI can be defined to be longer or shorter as desired. The detector can measure a plurality of signal intensities along first ROI 615. According to various embodiments, an ROI sum signal can be determined by summing the signal intensities measured by the detector in first ROI 615.

A second ROI comprising line segments 617 and 618 can then be defined to estimate a crosstalk signal. Although second ROI line segments 617 and 618 are depicted in FIG. 6 as immediately adjacent first ROI 615, one of ordinary skill in the art understands that second ROI line segments 617 and 618 can be defined as not immediately adjacent first ROI 615. The detector can measure a plurality of signal intensities along second ROI line segments 617 and 618.

An estimated crosstalk signal can then be determined using the plurality of signal intensities measured by the detector within second ROI line segments 617 and 618. In various embodiments, the estimated crosstalk signal can be determined by algebraically manipulating the signals measured by the detector within second ROI line segments 617 and 618. For example, the values of the signals measured by the detector within second ROI line segments 617 and 618 can be used to determine an average or a median value. In various other embodiments, curve fitting can be applied to the values of the signals measured by the detector within second ROI line segments 617 and 618 to determine an estimated crosstalk signal.

A corrected ROI signal for first ROI 615 can then be determined. For example, the estimated crosstalk signal can be multiplied by the number of signal values measured by the detector along second ROI line segments 617 and 618. The corrected ROI signal for first ROI 615 can then be calculated by subtracting the multiplied estimated crosstalk signal from the ROI sum signal. According to various embodiments, after completing the scanning of the wells in one column of microtiter plate 600, the detector can then scan the next column of wells. In this manner, corrected ROI signals can be determined for each well of microtiter plate 600.

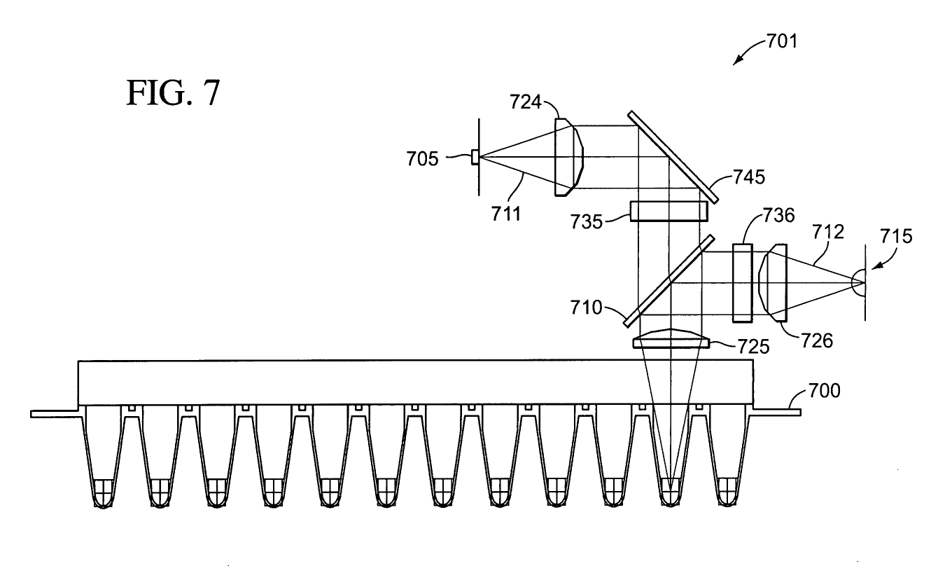

As disclosed above, an LED can be used as a light source and a photodiode can be used as a detector. Referring to FIG. 7, an exemplary LED/photodiode system 701 can include an LED 705, a beamsplitter 710, and photodetector 715. According to various embodiments, LED/photodiode system 701 can further include one or more lenses 724, 725, and 726, an excitation filter 735, and an emission filter 736. In various embodiments, LED/photodiode system 701 can further include a mirror 745 and/or a beam absorber (not shown). One of ordinary skill in the art understands that other optical components can be included in LED/photodiode system 701, such as, for example, a plurality of LEDs (not shown).

In operation, an excitation light 711 can be provided by LED 705. Excitation light 711 can pass through lens 724, be reflected from mirror 745, and pass through emission filter 735 and beamsplitter 710. Lens 725 can then focus excitation light 711 onto a microtiter plate 700. An emitted light 712 can be collected by lens 725 and directed by beamsplitter 710 towards excitation filter 736 Lens 726 can then focus emitted light 712 towards LED 715.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for reducing optical crosstalk in an optical array detector comprising:
measuring an optical signal intensity within a first region of interest (ROI) using a first plurality of pixels of the optical array detector;
measuring an optical signal intensity within a second ROI using a second plurality of pixels of the optical array detector, wherein the second ROI defines a region surrounding the first ROI;
estimating an optical crosstalk signal using the optical signal intensity within the second ROI; and
determining a corrected ROI signal for the first ROI by subtracting the estimated optical crosstalk signal from the optical signal intensity measured within the first ROI.

2. The method of claim 1, further comprising calculating an ROI sum signal by summing the values for optical signal intensity measured by each of the first plurality of pixels.

3. The method of claim 1, wherein the step of estimating an optical crosstalk signal using the optical signal intensity within the second ROI comprises algebraically manipulating values for optical signal intensity provided by each of the second plurality of pixels to determine the optical crosstalk signal.

4. The method of claim 2, wherein the step of determining a corrected ROI signal for the first ROI by subtracting the estimated optical crosstalk signal from the optical signal intensity measured within the first ROI further comprises multiplying the optical crosstalk signal by a number of pixels of the first plurality of pixels and subtracting the multiplied optical crosstalk signal from the ROI sum signal

5. The method of claim 1, wherein the ROI corresponds to a well in a microtiter plate.

6. The method of claim 1, wherein the second ROI corresponds to a ring-shaped region surrounding the first ROI.

7. The method of claim 1, wherein the step of measuring optical signal intensity within a region of interest (ROI) using a first plurality of pixels of the optical array detector comprises measuring fluorescent emission using a charge coupled device (CCD) during a PCR run.

8. The method of claim 3, wherein the step of algebraically manipulating the values for optical signal intensity comprises at least one of calculating an average, calculating a median, and curve fitting the values for optical signal intensity provided by the second plurality of pixels.

9. A method for reducing optical crosstalk in an optical array detector comprising:
a. measuring optical emission within a first region of interest (ROI) using a first plurality of pixels of the optical array detector, wherein each of the first plurality of pixels provides a value for optical signal intensity within the first ROI;
b. calculating an ROI sum signal by summing the values for optical signal intensity measured by the first plurality of pixels;
c. measuring an optical emission within a second ROI using a second plurality of pixels of the optical array detector, wherein each of the second plurality of pixels provides a value for optical signal intensity within the second ROI;
d. algebraically manipulating the values for optical signal intensity provided by the second plurality of pixels to determinate an optical crosstalk signal; and
e. determining a corrected ROI optical signal intensity by multiplying the optical crosstalk signal by a number of pixels of the first plurality of pixels and subtracting the multiplied optical crosstalk signal from the ROI sum signal.

10. The method of claim 9, further comprising performing steps a through e for a plurality of ROIs, wherein the plurality of ROIs correspond to a plurality of wells in a microplate.

11. The method of claim 10, further comprising determining a corrected ROI optical signal intensity for the plurality of ROIs at a plurality of time intervals.

12. The method of claim 10, further comprising monitoring the optical crosstalk signals determined at the plurality of time intervals and applying a smoothing function to the optical crosstalk signals.

13. The method of claim 10, wherein the ROI sum signals are stored separate from the optical crosstalk signals.

14. A computer-readable medium to reduce optical crosstalk in an optical array detector comprising:
program code to control measurement of a plurality of values for optical signal intensity within a plurality of regions of interest (ROIs) by an optical detector, wherein the plurality of ROIs corresponding to wells of a microtiter plate;
program code to calculate an ROI sum signal for each ROI by summing the plurality of values for optical signal intensity measured within each ROI;
program code to control measurement of a second plurality of values for optical signal intensity within a second plurality of ROIs, wherein each of the second plurality of ROIs comprises a ring-shaped region surrounding a corresponding ROI;
program code to calculate a crosstalk signal by algebraically manipulating the values for optical signal intensity measured within the second plurality of ROIs;
program code to obtain a product by multiplying the crosstalk signal by a number of pixels of the detector used to measure the optical signal intensity within one of the plurality of ROIs; and
program code to calculate a value for corrected optical signal intensity for each of the plurality of ROIs by subtracting the product from each of the ROI sum signals.

15. The computer readable medium of claim 14, wherein the program code for calculating the crosstalk signal comprises program code for at least one of calculating an average, calculating a median, and curve fitting the second plurality of values for optical signal intensity with the second plurality of ROIs.

16. The computer readable medium of claim 14, further comprising program code for calculating a value for corrected optical signal intensity for each of the plurality of ROIs at each of a plurality of time intervals (during a PCR run).

17. The computer readable medium of claim 16, further comprising:
program code for monitoring the values for corrected optical signal intensity for each of the plurality of ROIs determined at the plurality of time intervals; and
program code for applying a smoothing function to determine the crosstalk signal.

18. The computer readable medium of claim 14, further comprising program code for determining the second plurality of ROIs based on analysis of a calibration image that provides a high contrast optical signal intensity for each of the plurality of ROIs.

19. The computer readable medium of claim 14, further comprising program code for storing the ROI sum signals separate from the crosstalk signals.

20. The computer readable medium of claim 14, further comprising program code for controlling visual display of the corrected optical signal intensity for each of the plurality of ROIs.

21. A sequence detection system comprising:
a light source that provides a fluorescence excitation light;
a CCD camera that provide an image; and
the computer readable medium of claim 14.
